(19) United States
(12) Patent Application Publication
(10) Pub. No.: US 2002/0014966 A1
(43) Pub. Date: Feb. 7, 2002

(54) System and method for communicating information associated with a drilling component

(76) Inventors: Bernd H. Strassner II, College Station, TX (US); Kai Chang, College Station, TX (US); George M. Savage, Grove, OK (US); Paul C. Koomey, Houston, TX (US)

Correspondence Address: Baker Botts L.L.P., 2001 Ross Avenue, Suite 600, Dallas, TX, 75201-2980, US

(21) Appl. No.: 09/906,957

(22) Filed: Jul. 16, 2001

Related U.S. Application Data
(60) Provisional application No. 60/218,306, filed on Jul. 14, 2000.

(51) Int. Cl. G08B 13/14

(52) U.S. Cl. 340/572.1; 340/853.1

(57) ABSTRACT

According to one embodiment of the present invention, a method is provided that includes coupling an identification tag to a drilling component and providing information associated with the drilling component in the identification tag. The identification tag receives an incoming electromagnetic signal during an operation involving the drilling component. The identification tag responds to the incoming electromagnetic signal by communicating an outgoing electromagnetic signal that includes the information associated with the drilling component.

### TECHNICAL FIELD OF THE INVENTION

This invention relates generally to communicating information, and in particular to a system and method for communicating information associated with a drilling component.

### BACKGROUND OF THE INVENTION

Oil and gas exploration has become increasingly more important in today's society. One aspect of oil and gas exploration generally involves drilling, in which a series of components cooperate to drill into the earth's surface in an effort to achieve a number of results, such as discovering new energy reservoirs or enhancing the productivity of existing ones, for example. During a drilling operation a drilling rig or drilling derrick is generally erected and a series of lengths of drilling components capable of being coupled to each other in some fashion to form a drill string are used to facilitate the drilling operation. It may be advantageous to include some identification device on one or more drilling components that is capable of communicating information about a drilling component to a remote source or location to be received by a drilling system operator, for example. Previously proposed strategies that attempt to include some identification device or element capable of conveying information associated with one or more drilling components have been adequate for their intended purposes, but not satisfactory in all respects.

### SUMMARY OF THE INVENTION

According to one embodiment of the present invention, a method is provided that includes coupling an identification tag to a drilling component and providing information associated with the drilling component in the identification tag. The identification tag receives an incoming electromagnetic signal during an operation involving the drilling component. The identification tag responds to the incoming electromagnetic signal by communicating an outgoing electromagnetic signal that includes the information associated with the drilling component.

Embodiments of the present invention provide a number of technical advantages. According to one embodiment of the present invention, a battery, a voltage supply, or any other suitable power source is not required in order to achieve communication between the identification tag and a reader. This result is due, in part, to the passive nature of the identification tag's internal circuitry, as the transmitted electromagnetic energy received by the tag operates to supply the identification tag with the requisite power needed to communicate the response that includes information associated with the drilling component. This may be advantageous for several reasons. The lack of a power supply reduces the size of the identification tag and thus affords greater structure space to the associated drilling component to be used to enhance the strength of the component. Additionally, the absence of a power supply allows the identification tag to be used in virtually all environments, as temperature and pressure constraints, prohibitive for other batteries or power supplies, are avoided.

Additionally, according to the teachings of one embodiment of the present invention, information provided by the identification tag may be communicated a substantial distance from the associated drilling component and concurrent to drilling operations that involve the component. Essentially, communication between the identification tag and a remote source or location may be achieved provided there is an interposed line of sight and a suitable range between the two elements. Hence, drilling operations do not need to be suspended or delayed in order to: (1) gather the requisite or otherwise desired information communicated by the identification tag, or (2) establish a communication link by getting proximate to a drilling component while it is in operation. Other technical advantages are readily apparent to one skilled in the art from the following figures, descriptions, and claims.

### BRIEF DESCRIPTION OF THE DRAWINGS

A better understanding of the present invention will be realized from the detailed description which follows, taken in conjunction with the accompanying drawings in which:

FIG. 1A is a diagrammatic front view of a drilling system that includes a drill rig derrick and one or more identification tags;

FIG. 1B is a diagrammatic front view of a tool joint included in the drill rig derrick of FIG. 1A and further includes a block diagram illustrating the operation of the identification tag of FIG. 1A;

FIG. 2 is a diagrammatic sectional front view of the tool joint of FIG. 1A illustrating additional details of the position of the identification tag of FIG. 1A within a drill pipe;

FIG. 3A is a diagrammatic sectional side view of the identification tag of FIG. 1A;

FIG. 3B is a block diagram of the identification tag of FIG. 1A illustrating additional details of circuitry associated therewith;

FIG. 4A is a front view of an antenna element that is included within the identification tag of FIG. 1A; and

FIG. 4B is a front view of a portion of the antenna of FIG. 4A and further includes an associated diagrammatic side view of a portion of the identification tag of FIG. 1A.

### DETAILED DESCRIPTION OF EXAMPLE EMBODIMENTS OF THE PRESENT INVENTION

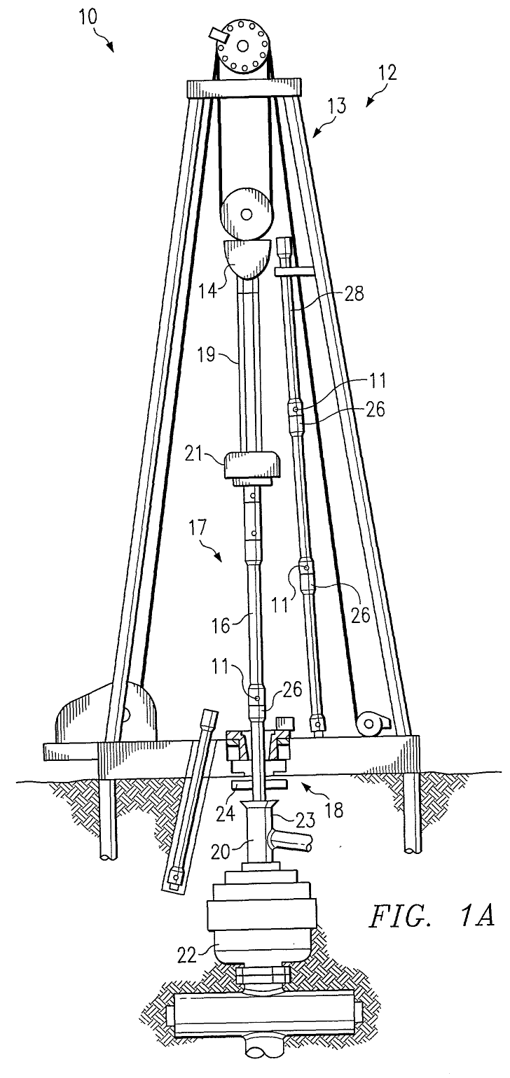

Example embodiments of the present invention and their advantages are best understood by referring now to FIGS. 1A through 4B of the drawings in which like numerals refer to like parts.

FIG. 1A is a diagrammatic front view of a drilling system 10 that includes a drill rig derrick 12 and one or more identification tags 11. Drill rig derrick 12 includes a support 13 supported through a pulley system and a swivel 14. Swivel 14 in turn supports a drill string 17. Drill string 17 is joined to swivel 14 through a Kelly joint 19 and a Kelly drive bushing 21.

Drill string 17 includes a plurality of drill pipes 16 coupled by a plurality of tool joints 26 and extends through a rotary table 18, and into a well bore 20 through a bell nipple 23 mounted on top of a blowout preventer stack 22. Well bore 20 provides a conduit to a potential energy source located below the earth's surface.

According to the teachings of one embodiment of the present invention, identification tag 11 may be provided on one or more drilling components, such as illustrated in FIG. 1A, associated with system 10, or drill pipe 16. An electromagnetic signal generator system 24 that includes an antenna 100 and a signal generator 124 is positioned proximate to identification tag 11, for example just below rotary table 18 as illustrated in FIG. 1A. Electromagnetic signal generator system 24 establishes a communications link with identification tag 11 to convey information relating to the associated drill pipe 16 as described in greater detail below.

Tool joint 26 is illustrated in FIG. 1A, as connecting two drilling components associated with drill rig derrick 12, such as drill pipes 16. According to one embodiment of the present invention, identification tag 11 is operable to communicate a response to an incoming electromagnetic signal generated by electromagnetic signal generator system 24 that includes information related to the drilling component that identification tag 11 is coupled thereto. The information may be used, for example, to inform an operator of system 10 of a drilling component's age, weaknesses, previous usage or adaptability. According to the teachings of the present invention, this information may be communicated while drill system 10 is in operation, in contrast to prior systems.

Some or all of the information provided in identification tag 11 may assist an operator in making a determination of when drilling components need to be replaced, or which drilling components may be used under certain conditions (for example, in high-stress or high-temperature environments). Cumulative use of drilling components often leads to inferior components being used in drilling operations. Use of weak drilling components may result in a break in a drill string and force abandonment of the well as there is generally neither an efficient nor economical way of removing the obstruction. Additionally, the electromagnetic signal communicated by identification tag 11 may provide general inventory management data (such as informing an operator of the drilling components availability on the drilling cite, or the drilling component's size, weight, etc.), or any other relevant drilling information associated with system 10.

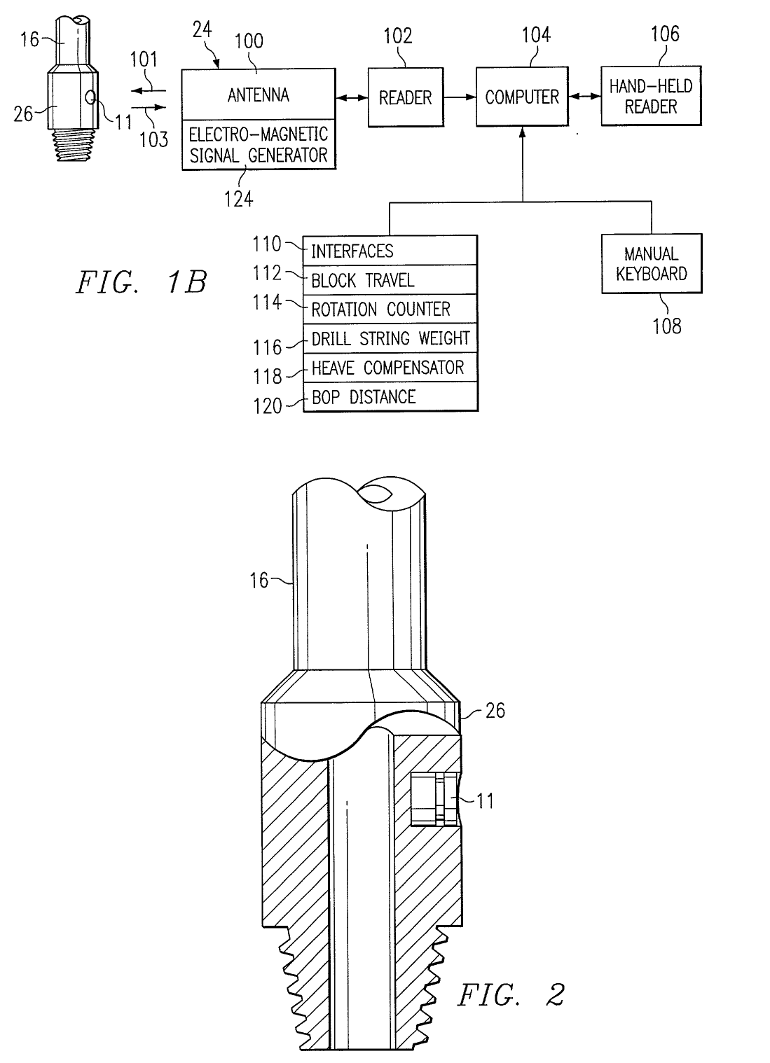

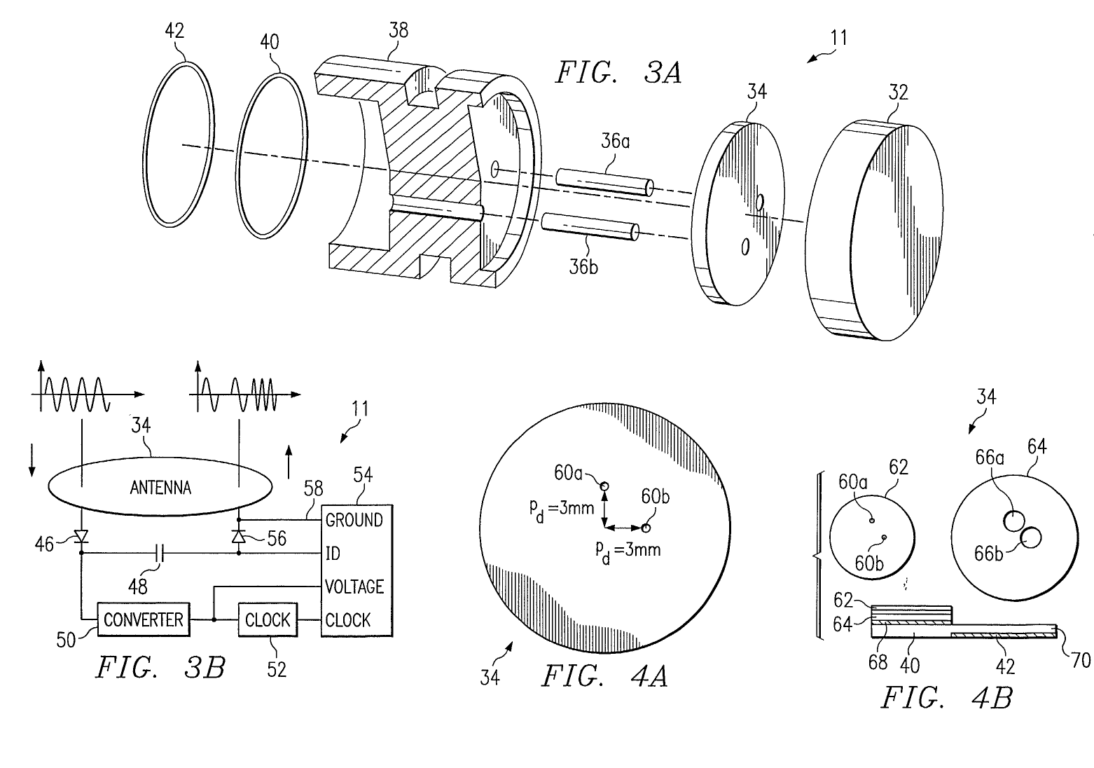

Additional details relating to the operation of identification tag 11 are described with reference to FIG. 1B. The placement and positioning of identification tag 11 is described with reference to FIGS. 2 and 3A. FIGS. 3B, 4A and 4B illustrate additional details relating to the circuitry and associated antenna design of identification tag 11.

Additional drill string components 28, which are illustrated in FIG. 1 in a racked position, may be coupled to drill pipe 16 and inserted into well bore 20, forming a portion of drill string 26. One or more of drill string components 28 may also include identification tag 11 as illustrated in FIG. 1A.

Operation of system 10 is described herein with reference to FIG. 1B. FIG. 1B is a diagrammatic front view of tool joint 26 included in drill rig derrick 12 of FIG. 1A and further includes a block diagram illustrating the operation of identification tag 11. FIG. 1B also shows typical information that may be included within identification tag 11, as antenna 100 cooperates with electromagnetic signal generator 124 to transmit an electromagnetic energizing signal 101 to identification tag 11. In this sense, electromagnetic signal generator 124 uses antenna 100 to interrogate identification tag 11 for desired information associated with a corresponding drilling component.

Antenna 100 communicates electromagnetic signal 101 (for example at a microwave energy level) to identification tag 11. Identification tag 11 responds to the transmitted electromagnetic signal by returning data or information 103 in an electromagnetic signal form that is received by antenna 100, and subsequently communicated to a reader 102. Reader 102 may subsequently process or simply store electromagnetic signal 103. According to one embodiment of the present invention, identification tag 11 communicates a coded 64-bit signal 101 to reader 102. Reader 102 may be handheld, i.e. mobile, or stationary according to particular needs.

According to the teachings of one embodiment of the present invention, identification tag 11 is passive and thus requires minimal incident power (for example power density in the approximate range of 15-25 mW/cm²) in order to establish a communications link between antenna 100 and identification tag 11. Passive refers to identification tag 11 not requiring a battery or any other power source in order to function. Identification tag 11 derives its requisite power to transmit an electromagnetic signal from the incoming electromagnetic signal, which it receives via antenna 100. The lack of a battery or other power supply reduces the size of identification tag 11, which allows a greater amount of space to be dedicated to the strength/integrity of an associated drilling component. Additionally, the absence of a battery or power supply allows identification tag 11 to be used in virtually all environments as temperature and pressure constraints, prohibitive for other batteries or power supplies, are effectively avoided. Alternatively, identification tag 11 may include a battery or other suitable power source that would enable identification tag 11 to communicate electromagnetic signal response 103.

Antenna 100 is coupled to reader 102 by any suitable wiring configuration, or alternatively, the two elements may communicate using any other appropriate wireless protocol. Reader 102 is coupled to a computer 104, which may include a monitor display and/or printing capabilities for the user. Computer 104 may be optionally coupled to a handheld reader 106 to be used on drill rig derrick 12. This allows for example, a user of handheld reader 106 to receive information from identification tag 11 remotely, i.e., a user of handheld reader 106 may be proximate to system 10 or mobile and continue to receive data and information relating to drilling components that include identification tag 11. Computer 104 may also be connected to a manual keyboard 108 permitting user entry into computer 104 of items such as drill string serial numbers, physical information (such as size, drilling component lengths, weight, age, etc.) well bore inclination, depth intervals, number of drill pipes in the drill string, and suspended loads or weights, for example.

For purposes of example, computer 104 is coupled to a series of interfaces 110 that may include one or more sensors capable of indicating any number of elements associated with drill rig derrick 12, such as: a block travel characteristic 112, a rotation counter characteristic 114, a drill string weight 116, a heave compensator 118, and a blowout preventer (BOP) distance sensor 120. One skilled in the art may appreciate that these sensors may provide pertinent information to drilling rig operators and/or drilling rig workers on the drilling site. A micro-controller may include one or more of these sensors or any other additional information; additional micro-controller applications are described in more detail with reference to FIG. 3B.

FIG. 2 is a diagrammatic sectional front view of tool joint 26 illustrating additional details of the position of identification tag 11 associated with drill pipe 16. A segment of tool joint 26 has been cut away to illustrate the placement of identification tag 11, which is in a semi-protected recess. According to the teachings of one embodiment of the present invention, identification tag 11 is recessed approximately 15-20 mm within a surface of a drilling component, such as drill pipe 16 and conventionally secured therein.

In order to facilitate electromagnetic communications, a line of sight should be maintained between identification tag 11 and antenna 100. Identification tag also includes an internal antenna (discussed in greater detail with reference to FIGS. 4A through 4B) that operates to receive and transmit electromagnetic signals. Because a line of sight optimizes the potential communication between antenna 100 and identification tag 11, an operator of system 10 may choose to establish such communications before the drilling component is inserted down a well hole and then at another time as the drilling component surfaces from the ground. Although described with reference to an example associated with microwave energy, the present invention contemplates that any energy level, capable of enabling identification tag 11 to respond to an incoming electromagnetic signal by re-transmitting a return electromagnetic signal, may be used. Although shown within tool joint 26, the present invention contemplates that antenna 11 may also be positioned at other convenient locations associated with a respective drill pipe 16.

FIG. 3A illustrates a diagrammatic sectional side view of identification tag 11 of FIG. 1A. According to the teachings of one embodiment of the present invention, identification tag 11 includes a disk 32, an antenna 34, a set of coaxial lines 36a and 36b, an outer protective casing 38, a radio frequency (RF) circuit 40 and a digital circuit 42 described in more detail with reference to FIG. 3B).

Disk 32 operates as a shield in protecting identification tag 11 from debris and other potential damage created by the down-hole environment and also operates as a sacrificial wear boundary (time and normal wear may cause a drilling component's diameter to decrease, disk 32 will also show evidence of wear). Disk 32 may be formed of Teflon, or any other suitable hardened substance capable of achieving such protection. Disk 32 also operates to clear drill mud or other debris from the surface of identification tag 11, thereby maximizing the clarity of an associated line of sight. Disk 32 may also be substantially transmissive with respect to the passage of electromagnetic communications, according to the illustrated embodiment.

Coaxial lines 36a and 36b are disposed in housing 38, and operate to interface between antenna 34 and RF circuit 40 and/or digital circuit 42. In one embodiment of the present invention, coaxial lines 36a and 36b are filled glass or ceramic material and have an approximate impedance of 70 ohms. Alternatively, coaxial lines 36a and 36b may be formed from any other suitable material and have any appropriate impedance characteristic. One end of each of coaxial lines 36a and 36b is coupled to two orthogonal ports of antenna 34. Additional details of these two ports are discussed below with reference to FIGS. 4A and 4B.

Casing 38 operates generally to protect the structure of identification tag 11. RF circuit 40, digital circuit 42, coaxial lines 36a and 36b, antenna 34 and disk 32 (exposed on one end of casing 38) are all enclosed within casing 38. Casing 38 may be formed from steel, hard plastic, or any other suitable device operable to afford such protection to identification tag FIG. 3B is a block diagram of identification tag 11 of FIG. 1A illustrating additional details of circuitry associated therewith. A continuous wave of electromagnetic energy (at approximately 5.6 to 6.0 Gigahertz, for example) is transmitted by antenna 24, (initiated by electromagnetic signal generator 24, as illustrated in FIG. 1B) and is received by antenna 34 of identification tag 11. According to the teachings of one embodiment of the present invention, antenna 34 is a circular patch antenna facilitating electromagnetic communications in the frequency range of 5.6 to 6.0 Gigahertz. The transmitted electromagnetic energy from electromagnetic signal generator 24 or reader 102 is linear and in a polarized form.

A Schottky diode 46 provided with identification tag 11 receives the incoming electromagnetic wave signal and rectifies a portion of the electromagnetic energy into direct current (DC) power. Schottky diode 46 also operates to generate a series of associated harmonics of approximately the 5.8 Gigahertz frequency, (for example 11.6 Gigahertz, 17.4 Gigahertz, and all other subsequent harmonics). In this sense, Schottky diode 46 hosts a mixing process for an incoming electromagnetic signal. Rectification of the incoming continuous wave signal may be dependent on impedance matching and loading characteristics associated with the circuitry of identification tag 11.

Schottky diode 46 communicates the portion of the continuous wave signal at approximately 5.8 Gigahertz frequency to a capacitor 48. This portion of the signal flows through capacitor 48, as capacitor 48 may operate as a DC block as well as an RF short (DC energy is blocked by capacitor 48, whereas RF energy passes through capacitor 48). Thus, capacitor 48 may operate to maintain a constant voltage (1 volt for example) on one side of capacitor 48 that includes Schottky diode 46, while maintaining a different voltage (3 volts for example) on the other side of capacitor 48. Energy from the 5.8 Gigahertz signal flows from capacitor 48 to a pin diode 56, which will be discussed in greater detail below.

The portion of the incoming continuous electromagnetic wave that is not at 5.8 Gigahertz, i.e. not flowing to capacitor 48, flows to a voltage converter 50; this is because only DC power is fed to the appropriate receiving electronics. Voltage converter 50 may be any device or component operable to modify a voltage potential, such as a DC to DC converter, for example. According to the teachings of one embodiment of the present invention, voltage converter 50 increases an incoming voltage (of 1 volt for example) to a level (3 volts for example) suitable to enable proper functionality of a clock 52 and a micro-controller 54.

Clock 52 uses the voltage potential that it receives to generate a clock pulse that is received by micro-controller 54. Micro-controller 54 responds to the clock pulse by executing the commands that micro-controller 54 is programmed to perform. According to the teachings of the present invention, micro-controller 54 may execute any given set of commands or instructions associated with drilling operations and may also store or otherwise process any other information or data relating to a drilling component or any other element according to particular needs. Micro-controller 54 also operates to generate an identification code in accordance with one embodiment of the present invention. The identification code in turn operates to bias pin diode 56. While described with reference to a potential alpha-numeric type of ID code, the ID code may alternatively be any other type of identifying representation according to particular needs and further, be in a variety of bit formats or other suitable communication protocols where appropriate.

As described above, pin diode 56 also receives the 5.8 Gigahertz signal, via capacitor 48. With the identification code received from micro-controller 54, and the 5.8 Gigahertz signal, pin diode 56 modulates or otherwise combines the two elements. Thus, the identification code is impressed on the carrier (the 5.8 Gigahertz signal) and subsequent pin diode 56 operates to transmit the identification code and carrier signal out of antenna 34 and back to reader 102 or any other receiving unit according to particular needs. A ground 58 is provided on a side of pin diode 56. Ground 58 operates to ensure that even if antenna 34 is somehow shorted with the exterior of identification tag 11 or any other small piece of material or debris, the circuitry of identification tag 11 will still be functionally operational. This is because identification tag 11 is conventionally grounded as well, thus the above-identified short would have no effect on the internal system of identification tag 11.

The present invention contemplates that the above-identified elements that make up identification tag 11 may be included onto a single integrated chip (IC). Particularly in the context of installation within a drilling component, the size of identification tag 11 may be critical. As identification tag 11 increases in size and/or dimensions, strength-related concerns of an associated component are heightened. Optimally, identification tag 11 occupies a minimal amount of space so maximum strength of a drilling component is achieved.

FIG. 4A is a front view of antenna 34 that is included in the identification tag 11 of FIG. 1A. Antenna 34 is a circular piece of metal that is disposed above a ground place (i.e. separated by metalization) and includes a dielectric. According to one embodiment of the present invention, antenna 34 has a diameter of approximately 18 mm and includes a set of orthogonal ports 60a and 60b for receiving coaxial lines 36a and 36b. The present invention contemplates however that any appropriate dimensions of antenna 34 and any number of suitable ports may be used according to particular needs.

FIG. 4B is a front view of a portion of antenna 34 of FIG. 4A and further includes an associated diagrammatic side view of a portion of identification tag 11. According to one embodiment of the present invention, antenna 34 includes an antenna layer 62 that includes orthogonal ports 60a and 60b. Disposed adjacent to antenna layer 62 is an antenna ground layer 64; antenna ground layer 64 also includes a set of orthogonal ports 66a and 66b. A ground layer 68 is provided, which isolates a substrate 70 from antenna ground layer 64. Adjacent to substrate 70 is both RF circuit 40 and digital circuit 42. FIG. 4B represent an example topology of antenna 34, the present invention contemplates that various other suitable alterations and modifications to this arrangement of elements of antenna 34 may be made where appropriate according to particular needs.

Unlike previous systems that operate at substantially lower frequencies, some embodiments of the present invention operate at a higher frequency allowing drilling operations to continue as information relating to an associated drilling component is communicated to reader 102. Because of the strength of the communicated electromagnetic signal in accordance with these embodiments, communication with identification tag 11, even if mobile at the time electromagnetic communications were initiated, is effectively established. This result is advantageous as undue delay and intermittent suspension of operations to gather the requisite information relating to a drilling component is substantially eliminated. By operating at a higher frequency, the present invention is also able to overcome debris and other foreign particles that may otherwise interfere with electromagnetic communications. Some embodiments of the present invention are also operational from a distance that allows drilling operations to be maintained as information is communicated.

Although several embodiments have been illustrated and described in detail, it will be understood that various substitutions and alterations can be made therein within departing from the present invention. For example, although system 10 is described with reference to reader 102 and electromagnetic signal generator system 24 as disposed proximate to drilling components within drill rig derrick 12, these components may be placed anywhere proximate to drill rig derrick 12, separately or together. Additionally, these two components may be included in one single handheld or otherwise hardwired device to be operated by a single user in any remote location. A handheld wireless remote device would provide the advantage of mobility to a drilling rig operator, as he would be free to venture anywhere within a potential line of sight of identification tag 11 and still receive associated information or data relating to a drilling component.

Also, although the present invention is described with reference to electromagnetic communications at a frequency range of approximately 5.6 to 6.0 Gigahertz, any other suitable frequencies may be used in conjunction with identification tag 11. Numerous other changes, substitutions, variations, alterations, and modifications may be suggested to one skilled in the art, and it is intended that the present invention encompass all such changes, substitutions, variations, alterations, and modifications as falling within the spirit and scope of the appended claims.

What is claimed is:

1. An apparatus comprising:
an identification tag coupled to a drilling component, the identification tag operable to receive an incoming electromagnetic signal during an operation involving the drilling component and respond to the incoming electromagnetic signal by communicating an outgoing electromagnetic signal that includes information associated with the drilling component.

2. The apparatus of claim 1, wherein the identification tag utilizes energy from the incoming electromagnetic signal to communicate the outgoing electromagnetic signal.

3. The apparatus of claim 2, wherein the identification tag includes an antenna, the antenna operable to facilitate electromagnetic communications at a frequency range of approximately 5.6 to 6.0 Gigahertz.

4. The apparatus of claim 3, wherein dimensions of the antenna are selected based on impedance matching factors associated with the antenna.

5. The apparatus of claim 1, wherein the identification tag includes two or more orthogonal ports operable to facilitate communication of electromagnetic energy simultaneously, and wherein at least one port operates to receive the incoming electromagnetic signal and at least one other port operates to communicate the outgoing electromagnetic signal.

6. The apparatus of claim 1, further comprising an electromagnetic signal generator system disposed proximate to the identification tag and operable to communicate the incoming electromagnetic signal that is received by the identification tag.

7. The apparatus of claim 6, further comprising a receiver that includes an antenna operable to receive the outgoing electromagnetic signal communicated by the identification tag, wherein the receiver is coupled to a reader operable to process the outgoing electromagnetic signal, and wherein the receiver is coupled to a computer operable to display the information associated with the drilling component.

8. The apparatus of claim 1, wherein the identification tag includes a micro-controller operable to store the information associated with the drilling component, and wherein the micro-controller is operable to be programmed to store additional information associated with drilling operations.

9. The apparatus of claim 1, further comprising a database, wherein the database is operable to store a portion of the outgoing electromagnetic signal that includes the information associated with the drilling component.

10. An apparatus comprising:
an identification tag coupled to a drilling component, the identification tag operable to receive an incoming electromagnetic signal during an operation that involves the drilling component and respond to the incoming electromagnetic signal by communicating an outgoing electromagnetic signal that includes information associated with the drilling component, wherein the identification tag utilizes energy from the incoming electromagnetic signal to communicate the outgoing electromagnetic signal, the identification tag including an antenna and the antenna operable to facilitate electromagnetic communications at a frequency range of approximately 5.6 to 6.0 Gigahertz, and wherein the identification tag includes a micro-controller operable to store the information associated with the drilling component, the micro-controller being further operable to be programmed to store additional information associated with drilling operations.

11. A system for communicating information, comprising:
an identification tag coupled to a drilling component, the identification tag operable to receive an incoming electromagnetic signal during an operation involving the drilling component and respond to the incoming electromagnetic signal by communicating an outgoing electromagnetic signal that includes information associated with the drilling component, wherein the identification tag utilizes energy from the incoming electromagnetic signal to communicate the outgoing electromagnetic signal;
an electromagnetic signal generator system disposed proximate to the identification tag and operable to communicate the incoming electromagnetic signal that is received by the identification tag; and
a receiver that includes a receiving antenna that is coupled to the receiver and that is operable to receive the outgoing electromagnetic signal communicated by the identification tag, wherein the receiver is coupled to a reader operable to process the outgoing electromagnetic signal, and wherein the receiver is coupled to a computer operable to display the information associated with the drilling component.

12. An identification tag comprising:
a first antenna operable to receive an electromagnetic signal;
a Schottky diode operable to receive the electromagnetic signal from the first antenna and to rectify a first portion of the electromagnetic signal into a direct current (DC) power, wherein the Schottky diode is further operable to communicate the first portion to a capacitor;
a voltage converter operable to receive a second portion of the electromagnetic signal that is not communicated to the capacitor, wherein the voltage converter is further operable to increase a voltage potential associated with the second portion;
a micro-controller operable to receive power communicated by the voltage converter such that it is capable of generating an electromagnetic signal to be transmitted, wherein the micro-controller is further operable to execute a set of commands after receiving power communicated by the voltage converter and to generate an identification code;
a pin diode operable to receive the identification code from the micro-controller and the first portion of the electromagnetic signal from the capacitor, the pin diode integrating the first portion and the identification code to form a new signal to be transmitted to a second antenna; and
a reader operable to receive the new signal from the second antenna.

13. A method comprising the steps of:
coupling an identification tag to a drilling component;
providing information associated with the drilling component in the identification tag;
receiving, by the identification tag, an incoming electromagnetic signal during an operation involving the drilling component; and
responding to the incoming electromagnetic signal, by the identification tag, by communicating an outgoing electromagnetic signal that includes the information associated with the drilling component.

14. The method of claim 13, further comprising the step of utilizing energy from the incoming electromagnetic signal, by the identification tag, to communicate the outgoing electromagnetic signal.

15. The method of claim 14, further comprising the step of conducting electromagnetic communications at a frequency range of approximately 5.6 Gigahertz to 6.0 Gigahertz.

16. The method of claim 13, further comprising the step of providing at least two orthogonal ports in the identification tag such that one port operates to receive the incoming electromagnetic signal and the other port operates to communicate the outgoing electromagnetic signal.

17. The method of claim 13, further comprising the step of positioning an electromagnetic signal generator system proximate to the identification tag and operable to communicate the incoming electromagnetic signal that is received by the identification tag.

18. The method of claim 17, further comprising the step of receiving the outgoing electromagnetic signal communicated by the identification tag at a receiver, wherein the receiver is coupled to a reader operable to process the outgoing electromagnetic signal, and wherein the reader is coupled to a computer operable to display the information associated with the drilling component.

19. The apparatus of claim 13, further comprising the step of storing the information associated with the drilling component in a micro-controller, wherein the micro-controller is operable to be programmed to store additional information associated with drilling operations.

20. The apparatus of claim 13, further comprising the step of storing a portion of the outgoing electromagnetic signal that includes the information associated with the drilling component in a database, wherein the database is operable to be accessed.

21. A method comprising the steps of:
receiving an incoming electromagnetic signal with an identification tag that is attached to a drilling component during an operation involving the drilling component;
responding to the incoming electromagnetic signal by communicating an outgoing electromagnetic signal that includes information associated with the drilling component; and
utilizing, by the tag, energy from the incoming electromagnetic signal to communicate the outgoing electromagnetic signal, wherein the identification tag includes an antenna, the antenna operable to facilitate electromagnetic communications at a frequency range of approximately 5.6 Gigahertz to 6.0 Gigahertz, and wherein the identification tag includes a micro-controller operable to store the information associated with the drilling component and to be programmed to store additional information associated with drilling operations.
